(19) United States
(12) Patent Application Publication
(10) Pub. No.: US 2015/0360400 A1
(43) Pub. Date: Dec. 17, 2015

(54) IMPRINT METHOD, IMPRINT APPARATUS, AND ARTICLE MANUFACTURING METHOD

(71) Applicant: CANON KABUSHIKI KAISHA, Tokyo (JP)

(72) Inventor: Naoya Tsurumi, Shioya-gun (JP)

(21) Appl. No.: 14/736,953

(22) Filed: Jun. 11, 2015

(30) Foreign Application Priority Data
Jun. 13, 2014 (JP) 2014-121986

(51) Int. Cl. B29C 43/58; B29C 59/02; B29C 43/02

(52) U.S. Cl. CPC B29C 43/58; B29C 43/021; B29C 59/022; B29C 2043/5875

(57) ABSTRACT

Provided is an imprint method for forming a pattern of an imprint material on a substrate, the imprint method comprising: applying a drop of the imprint material to the substrate; observing the applied drop; acquiring information concerning a Newton's ring of the drop and a diameter of the drop from the observation result; and determining an application condition of the imprint material in forming the pattern based on the acquired information.

### BACKGROUND OF THE INVENTION

1. Field of the Invention

The present invention relates to an imprint method, an imprint apparatus, and an article manufacturing method.

2. Description of the Related Art

In addition to a conventionally photolithography technique, there is a microfabrication technique in which resin (imprint material) on a substrate is molded by a mold and a resin pattern is formed on the substrate. This technique is also referred to as an “imprint technique”, and can form a fine structure on the order of a few nano. One example of imprint techniques includes a photo-curing method. An imprint apparatus employing the photo-curing method first applies a photocurable resin to one of the shot areas on a substrate. Next, the resin on the substrate is molded by using a mold with a pattern portion. The resin is cured by the irradiation of light, the mold is released from the resin, and the resin pattern is thereby formed on the substrate. Note that a heat cycle method may be employed as well as the photo-curing method. These methods differ in a process for curing resin, but have basically the same process to form a resin pattern by using a mold.

When the mold contacts with the resin on the substrate, such lithography apparatuses require causing the desired amount of drops of the resin to arrive precisely at a predetermined position on the substrate such that the resin covers the pattern portion of the mold without empty spaces. Moreover, there is a case where the resin cannot cover the pattern portion of the mold without empty spaces, and the pattern portion is not filled, the thickness of film after the imprint process is uneven, and manufactured article cannot be used as product since the drop continues to volatilize during a period from the application to the substrate to the formation. Accordingly, it is desired that the application amount of the applied drop, the arrival position, and the volatilizing amount until formation are acquired in advance, and the imprint condition for compensating them is determined before the actual imprint process. Japanese Publication of PCT International Application No. 2012-506635 discloses that a drop (droplet) of the resin on the substrate is observed by a microscope and evaluated when the imprint condition is obtained.

In this context, Japanese Publication of PCT International Application No. 2012-506635 discloses that the volume of a drop is determined based on the information obtained by observing the drop, and the drop applied finally is adjusted so as to have a target volume. Specifically, when the drop has a large volume, a visual system images the side and the upper surface of the drop, and the volume is determined based on the geometric shape (for example, a height or a radius of the drop) of the drop by calculation. However, in order to image the side of the drop, a special imaging unit or a mechanism for driving the imaging unit for imaging the upper surface to image the side of the drop is needed, and thereby the flexibility of device space or sequence may become low.

### SUMMARY OF THE INVENTION

The present invention provides, for example, an imprint method advantageous for efficiently determining an application condition of an imprint material.

According to an aspect of the present invention, an imprint method for forming a pattern of an imprint material on a substrate is provided, the imprint method comprising: applying a drop of the imprint material to the substrate; observing the applied drop; acquiring information concerning a Newton's ring of the drop and a diameter of the drop from the observation result; and determining an application condition of the imprint material in forming the pattern based on the acquired information.

Further features of the present invention will become apparent from the following description of exemplary embodiments (with reference to the attached drawings).

### BRIEF DESCRIPTION OF THE DRAWINGS

FIG. 1 illustrates a configuration of an imprint apparatus according to one embodiment of the present invention.

FIGS. 2A to 2C illustrate the states of resin applied to shot area on a substrate.

FIG. 3A illustrates the state of resin applied to a large area imprint.

FIG. 3B illustrates the state of resin applied to a multi-area imprint.

FIGS. 4A to 4C illustrate processes for observing the resin applied to the substrate in time series.

FIG. 5 illustrates the contact angle of resin applied to the substrate.

FIG. 6 illustrates Newton's rings that can be obtained by observing the resin applied to the substrate.

FIG. 7 illustrates a first example of an arrangement of an observing unit in an imprint apparatus.

FIG. 8 illustrates a second example of an arrangement of the observing unit in the imprint apparatus.

### DESCRIPTION OF THE EMBODIMENTS

Hereinafter, preferred embodiments of the present invention will be described with reference to the drawings.

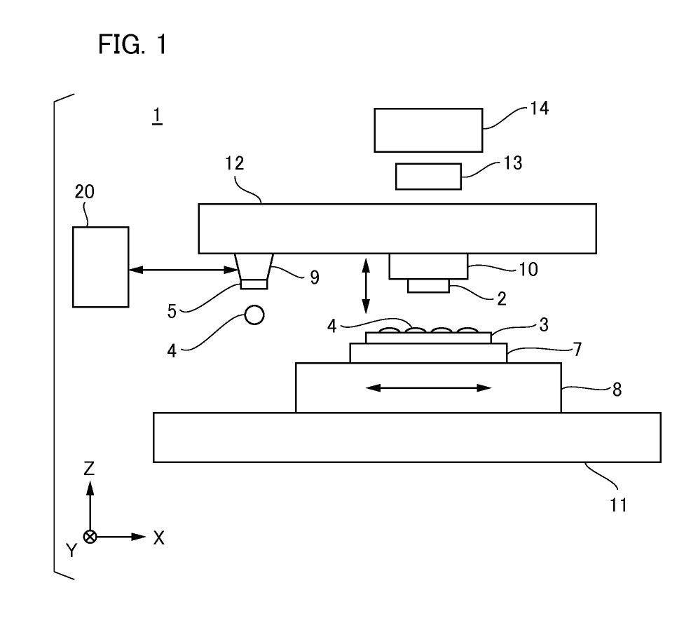

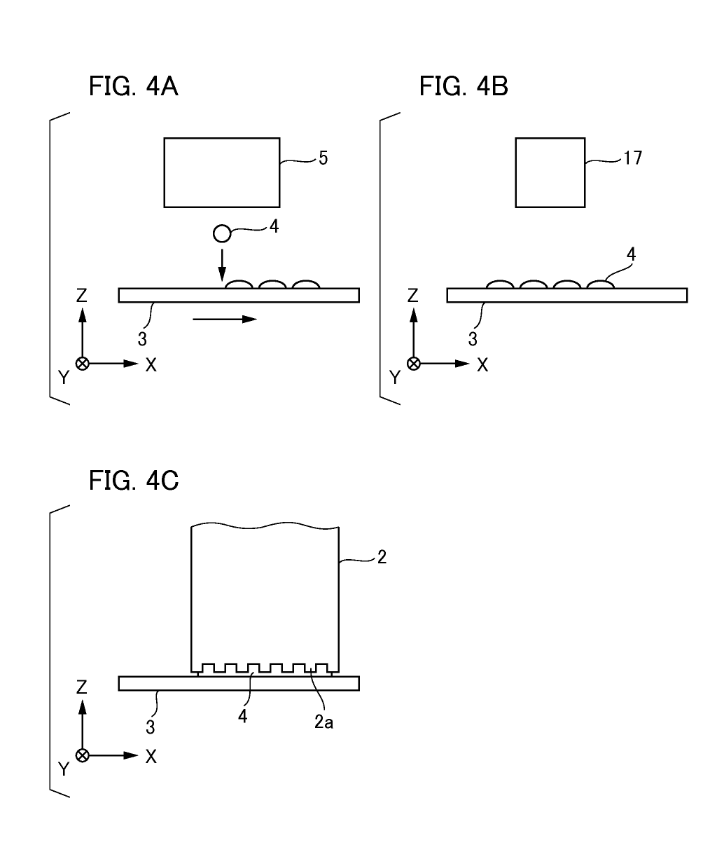

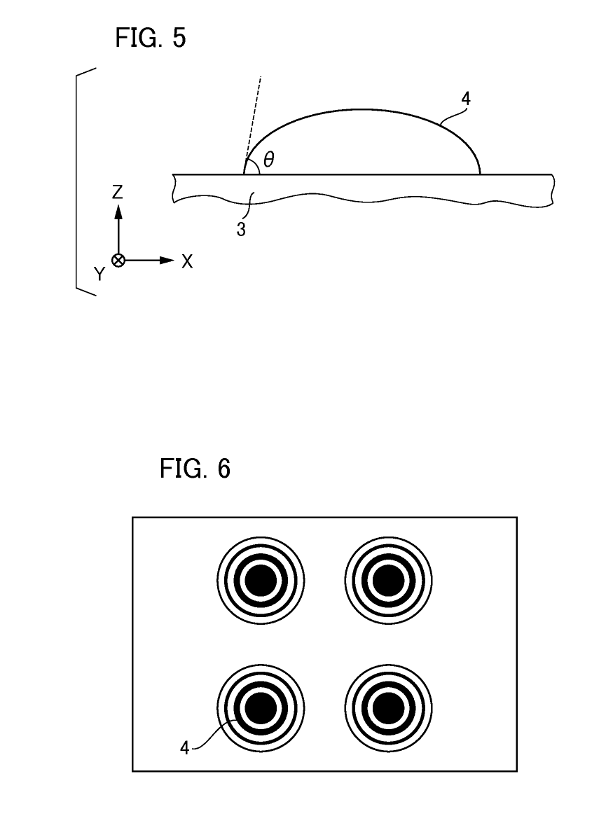

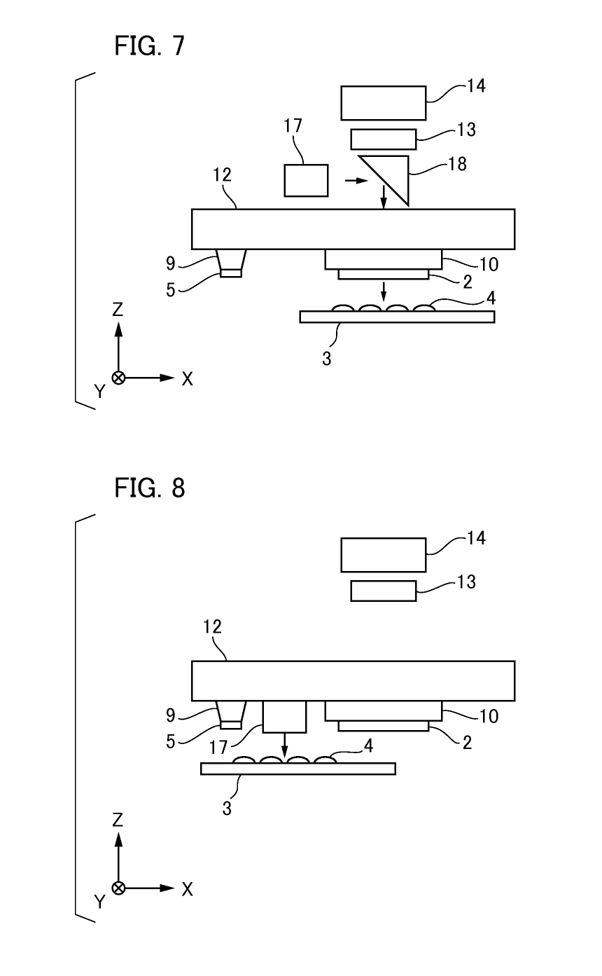

Firstly, a description will be given of an imprint apparatus according to one embodiment of the present invention. FIG. 1 is a schematic diagram illustrating a configuration of an imprint apparatus 1 according to the present embodiment. The imprint apparatus 1 is used in the manufacture of articles such as semiconductor devices and the like. The imprint apparatus 1 is an apparatus that contacts a mold 2 with an uncured resin 4 applied to a substrate 3 to thereby form the pattern of the resin 4 on the substrate 3. In the present embodiment, the imprint apparatus 1 employs a photo-curing method. In the following diagrams, the Z-axis is aligned in the perpendicular direction (vertical direction) and mutually orthogonal axes X and Y are aligned in a plane perpendicular to the Z axis. The imprint apparatus 1 comprises a light source 14, an illumination system 13, a mold holding mechanism 10, a substrate stage 8, a dispenser 9, an observing unit 17 (see FIG. 4B, FIG. 7 and the like) and a control unit 20.

The illumination system 13 adjusts ultraviolet rays emitted from the light source 14 to light suitable for imprinting and irradiates the light to the mold 2, in the imprint process. As the light source 14, a lamp such as a mercury lamp may be employed. The light source 14 is not particularly limited provided that the light source emits light that is transmitted through the mold 2 and has a wavelength for curing a resin 4. The present embodiment uses a light source that emits ultraviolet rays and an ultraviolet curable resin as resin 4. The illumination system 13 is provided since the present embodiment employs the photo-curing method. However, if a heat-curing method is employed, a heat source for curing a heat curable resin is provided.

The mold 2 includes a pattern portion 2a (see FIG. 4C, e.g., the concave and convex pattern of a circuit pattern or the like to be transferred), which is three-dimensionally formed on the surface facing the substrate 3. The mold holding mechanism 10 is supported by a structure 12, and has a mold chuck for holding the mold 2 and a mold driving mechanism for holding the mold chuck and moving the mold 2, which are not illustrated. The mold chuck can hold the mold 2 by attracting an outer periphery area on the irradiated surface of the mold 2 with a vacuum suction force or an electrostatic force. The mold chuck and the mold driving mechanism have an opening area at the center (on the inside) in order to cause the ultraviolet rays irradiated from the illumination system 13 to be transmitted in the mold 2 and be directed toward the substrate 3. The mold driving mechanism moves the mold 2 in each axis direction to selectively perform attraction and release between the mold 2 and the resin 4 on the substrate 3. Note that the attracting and releasing operation in the imprint process may be performed by moving the mold 2 in the Z axis direction, by moving the substrate stage 8 in the Z axis direction, or by relatively moving the mold 2 and the substrate stage 8.

The substrate 3 is, for example, a single crystal silicon wafer, a SOI (silicon on insulator) wafer. The substrate stage (substrate holder) 3 holds the substrate 3 and performs the positioning of the mold 2 and the resin 4 in contacting the mold 2 with the resin 4 on the substrate 3. The substrate stage 8 has a substrate chuck 7 that holds the substrate 3 by attraction force and a stage driving mechanism (not shown) that holds the substrate chuck 7 by a mechanical means and is movable in at least a direction along the surface of the substrate 3 on the stage base 11.

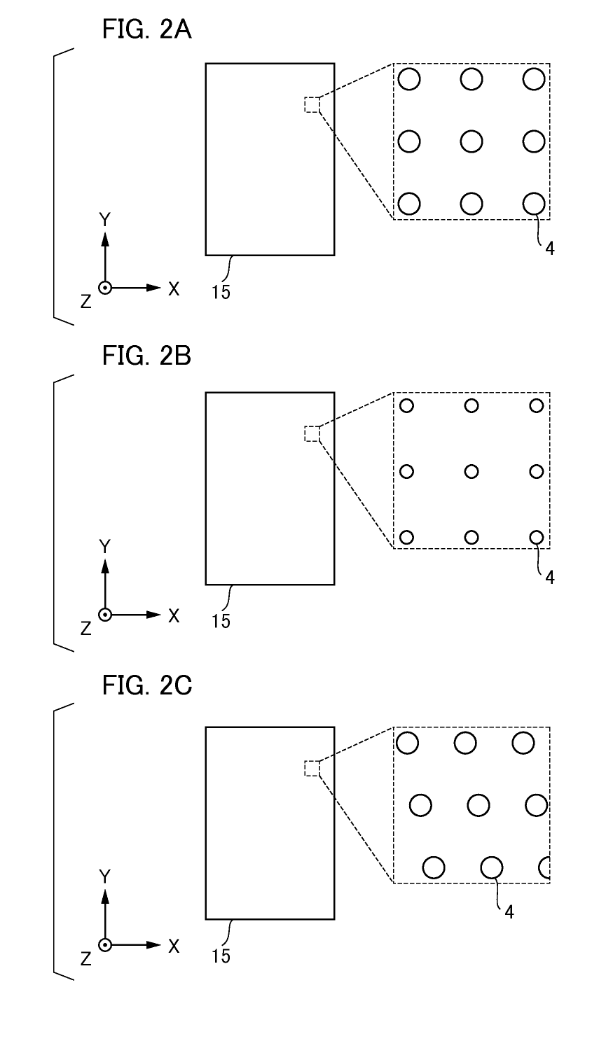

The dispenser 9 is located on the structure 12 near the mold holding mechanism 10 and applies the resin 4 to the shot area 15 (FIGS. 2A to 2C), which is on the substrate 3, as the pattern forming area with a predetermined applying amount and in a predetermined applying pattern. Here, the pattern portion 2a formed in the mold 2 has a coarse/fine distribution. Therefore, it is desired that the dispenser 9 applies the resin 4 onto the substrate 3 with an amount corresponding to this coarse/fine distribution. Accordingly, the resin 4 is preferably applied using an inkjet system. In this case, the dispenser 9 has an ejecting unit 5 that is used in the inkjet system. The resin 4 as an imprint material is a photocurable resin having the property of being cured by receiving the ultraviolet rays, and is appropriately selected based on various conditions such as the process for manufacturing an article. Note that a mold releasing agent is added to the resin 4, which facilitate the release of the mold 2 after contacting.

The observing unit 17 observes the drop of the resin 4 applied to the substrate 3 or a tool substrate for a dummy. For example, an optical microscope or the like may be employed as the observing unit 17. Note that the details such as the arrangement of the observing unit 17, an observing method by using the observing unit 17 and the like are described below.

The control unit 20 is configured of, for example, a computer that is connected to each component of the imprint apparatus 1 through lines, and can control the operation, the adjustment and the like of each component in accord with a program or the like. Note that the control unit 20 may be integrally configured with other parts of the imprint apparatus 1 (in a shared housing), or may be separately configured from other parts of the imprint apparatus 1 (in separate housings).

Next, a description will be given of an imprint process (imprint method) performed by the imprint apparatus 1. Firstly, the control unit 20 causes the substrate 3 to be mounted and fixed to the substrate chuck 7. Next, the control unit 20 drives the substrate stage 8 to appropriately change the position of the substrate 3 while the control unit 20 causes an alignment measurement system (not shown) to measure the alignment mark on the substrate 3 to detect the position of the substrate 3 with higher accuracy. Then, the control unit 20 calculates imprint coordinates and causes patterns to be formed at each predetermined shot area 15 based on the detection result. Here, the control unit 20 firstly causes the substrate stage 8 to perform to position the applying position on the substrate 3 under an ejecting port of the ejecting unit 5, as a flow for forming a pattern on one shot area 15. Subsequently, the dispenser 9 applies the resin 4 to the shot area 15 (applying step). Next, the control unit 20 causes the substrate stage 8 to move and position the substrate 3 such that the shot area 15 is a contact position directly under the pattern portion 2a. Next, the control unit 20 performs positioning between the pattern portion 2a and the substrate-side pattern on the shot area 15, magnification correcting of the pattern portion 2a and the like, and then the control unit 20 causes the mold holding mechanism 10 to be driven such that the pattern portion 2a contacts the resin 4 on the shot area 15 (contacting step). In the contacting step, the pattern portion 2a is filled with the resin 4. In this state, the illumination system 13 irradiates the ultraviolet rays from the back surface (upper surface) of the mold 2 for the predetermined time to cure the resin 4 by ultraviolet rays passed through the mold 2 (curing step). After the resin 4 is cured, the control unit 20 causes the mold holding mechanism 10 to be driven again to release the pattern portion 2a from the substrate 3 (releasing step). Accordingly, the resin pattern (resin layer) copying the pattern portion 2a is formed three-dimensionally on the shot area 15. The imprint apparatus 1 executes such a series of imprint operations several times while the shot area 15 is changed by driving the substrate stage 8, such that the plurality of resin patterns can be formed on one substrate 3.

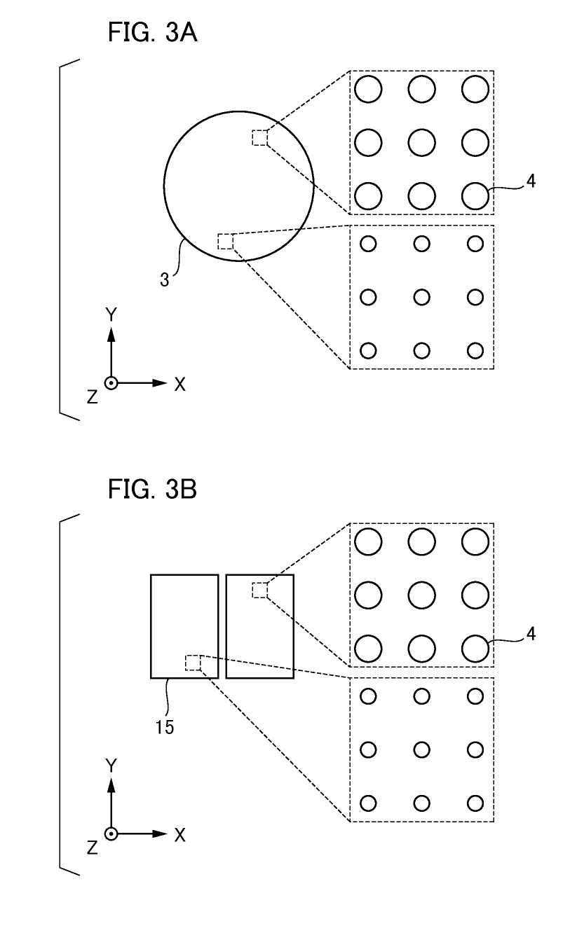

FIGS. 2A to 2C are schematic diagrams illustrating drop patterns of the resin 4 applied to the shot area 15. Here, FIGS. 2A to 2C show the drop patterns of a resin 4 included in an enlarged part of a portion of the shot area 15 surrounded by a broken line. Among these, FIG. 2A illustrates the state of applying the desired amount of resin 4 to predetermined position. FIG. 2B illustrates the state of applying the smaller amount of resin 4 than the desired amount and having a smaller drop shape after applying than the desired shape. Outside of these, there are a case where the drop shape after applying becomes larger than the desired shape due to the application of the larger amount of resin 4 than the desired amount, and a case where a portion of the drop shape is too small and a portion of the drop shape is too large are mixed within one shot area 15 to generate unevenness in the drop distribution actually. Moreover, FIG. 2C illustrates the state of applying the resin 4 to a position shifted from the predetermined position. In this case, the resin 4 cannot be spread over the pattern portion 2a of the mold 2 without empty spaces, and the phenomenon may be generated in which so-called “non-filling” has occurred, the film thickness after contacting cannot be even, and the resin pattern cannot be formed normally. In contrast, if the resin 4 is applied as shown in FIG. 2A, the drop shape may become small in contacting as shown FIG. 2B, since the resin 4 applied to the substrate 3 volatilizes before contacting with the mold 2. In addition, the volatilizing amount difference depending on positions within one shot area 15 may occur due to an influence of the ambient environment, such as airflow and the application steps performed several times such that unevenness may be generated in drop distribution. These adverse influences are remarkable in so-called “large area imprint”, in which an area that is larger than the shot area 15 is imprinted at a time, and so-called “multi-area imprint”, in which a plurality of shot areas 15 are imprinted repeatedly. FIG. 3A is a schematic diagram illustrating the unevenness of the drop distribution that can occur in the large area imprint, and FIG. 3B is a schematic diagram illustrating the unevenness of the drop distribution that can occur in the multi-area imprint.

In order to suppress such an adverse influence, in the present embodiment, the information such as the application amount (ejected amount) and an arrival position of drop of resin 4, or volatilizing speed before molding and unevenness due to volatilization, is obtained in advance by the following method, and is reflected in an imprint condition to be referred to during the actual imprint process. Here, the imprint condition in the present embodiment includes the application condition, in particular, concerning the dispenser 9 and the resin 4. Specifically, the kind or mixture of the resin 4, the mechanism or application method of the dispenser 9, the application amount or applied pattern of the drop, the ambient environment adjacent to the applied drop, the operation of imprint process or the sequence before the imprint process, or the like is considered as the application condition. Note that the condition considered above is one example and the application condition is not limited thereto.

FIGS. 4A to 4C are schematic diagrams illustrating a step for observing a drop by the observing unit 17 in a time series. Firstly, the substrate stage 8 moves the substrate 3 (or a tool substrate) directly under the ejecting unit 5 of the dispenser 9, and the dispenser 9 applies the resin 4 to the substrate 3 (the ejecting unit 5 ejects the drop), as shown in FIG. 4A. Next, the substrate stage 8 moves the substrate 3 such that the applied drop is within the observable range for the observing unit 17, and then the observing unit 17 observes the drop on the substrate 3, as shown in FIG. 4B. The control unit 20 can determine the application amount of drop, the arrival position of drop, or their unevenness based on the observation result at this time. In addition, the observing unit 17 continuously observes the volatilization of drop under this state, and thereby the control unit 20 can determine the volatilizing amount of resin 4 (including the volatilizing speed or unevenness due to volatilization) based on the observation result in this time. Note that the substrate 3 (the substrate stage 8) does not necessarily stop during the observation of the drop by the observing unit 17. At this time, the observation result that can determine the desired information may be obtained while the drop on the substrate 3 is within the observable range, and the substrate 3 can stop or move. The control unit 20 determines the imprint condition based on this information as a step for determining the condition, and performs the general imprint process as shown in FIG. 4C to form a preferable resin pattern on the substrate 3. Note that the observation result process is performed by an information processing apparatus external to the imprint apparatus 1 instead of the control unit 20, and then the control unit 20 may obtain and store the processing result or the imprint condition that has been determined based on the processing result.

Here, the control unit 20 may determine a volume of a drop of the resin 4 applied to the substrate 3 based on the observation result by the observing unit 17, and determine the imprint condition (the application condition) based on the volume. FIG. 5 is a diagram illustrating the contact angle of the drop of resin 4 applied to the substrate 3, with regard to a first method for determining the volume of the drop. When the drop of the resin 4 contacts the surface of the substrate 3, the shape of the drop is made by the contact angle determined by the combination of the resin 4 and the substrate 3. Therefore, the control unit 20 can determine the volume of a drop based on the shape of the drop determined in advance and the diameter of the drop determined from the observation result by the observing unit 17. Next, FIG. 6 is a schematic diagram illustrating the Newton's ring that is determined based on the observation result acquired in the observation step by the control unit 20 as a step for acquiring information and is generated by interference of light in the drop, with regard to a second method for determining the volume of the drop. The number of fringes of the Newton's ring is determined by the wavelength of observing light and the shape of a drop. Therefore, the control unit 20 can determine the volume of the drop based on acquired information about the Newton's ring (in particular, the number of fringes of the Newton's ring) and the diameter of the drop.

Next, a description will be given of an arrangement of the observing unit 17 and an observing method of the drop of resin 4 by the observing unit 17. FIG. 7 is a schematic diagram illustrating a first example of the arrangement of the observing unit 17 in the imprint apparatus 1. In the first example, the observing unit 17 is arranged at a position where the drop applied to the substrate 3 can be observed in the imprint position. Specifically, a half mirror 18 that does not block off the ultraviolet rays is provided in an optical path of the ultraviolet rays irradiated from the light source 14 directly under the illumination system 13, and the observing unit 17 is arranged at a position where the drop can be observed via the half mirror 18 and the mold 2. Note that the arrangement of the light source 14 and the illumination system 13 may be substituted by the arrangement of the observing unit 17. In addition, provided that the drop in the imprint position can be observed from the observing unit 17, the present invention cannot be limited to the configuration using such a half mirror 18.

FIG. 8 is a schematic diagram illustrating a second example of the arrangement of the observing unit 17 in the imprint apparatus 1, similar to FIG. 7. In the second example, the observing unit 17 is arranged at a position where the observation of the applied drop may be performed, outside of the imprint position. In particular, the observing unit 17 is arranged at a position where the observing area overlaps the movable area after applying the resin 4 to the substrate 3.

Note that from the point of view of observation accuracy, the observing unit 17 may be provided in several positions in the imprint apparatus 1 and may perform the observation from each position, and the observing unit 17 may perform the observation several times.

As described above, the imprint apparatus 1 obtains the imprint condition, specifically the application condition of the resin 4 by the dispenser 9, particularly based on the information about the Newton's ring and the diameter of the drop of the resin 4 applied to the substrate 3, which is acquired by using the observing unit 17. Accordingly, the observation result can be reflected in the application condition in the actual imprint process by observing the drop on the substrate 3 without arranging another observing unit for observing the side of the drop. In addition, in a case where the application amount is determined by observing the thickness of the film after transferring, it is difficult to estimate the ejecting amount, the arrival position, and the volatilizing amount separately. However, according to the present embodiment, they can be estimated separately.

As described above, according to the present embodiment, an imprint method and an imprint apparatus advantageous for efficiently determining an application condition of an imprint material can be provided.

### (Article Manufacturing Method)

A method for manufacturing a device (semiconductor integrated circuit element, liquid display element, or the like) as an article may include a step of forming a pattern on a substrate (wafer, glass plate, film-like substrate, or the like) using the imprint apparatus described above. Furthermore, the manufacturing method may include a step of etching the substrate on which a pattern has been formed. When other articles such as a patterned medium (storage medium), an optical element, or the like are manufactured, the manufacturing method may include another step of processing the substrate on which a pattern has been formed instead of the etching step. The device manufacturing method of the present embodiment has an advantage, as compared with a conventional method, in at least one of performance, quality, productivity and production cost of an article.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-121986 filed Jun. 13, 2014, which is hereby incorporated by reference herein in its entirety.

What is claimed is:

1. An imprint method for forming a pattern of an imprint material on a substrate, the imprint method comprising:
applying a drop of the imprint material to the substrate;
observing the applied drop;
acquiring information concerning a Newton's ring of the drop and a diameter of the drop from the observation result; and
determining an application condition of the imprint material in forming the pattern based on the acquired information.

2. The imprint method according to claim 1, wherein the imprint material is any one of an ultraviolet curable resin and a heat curable resin.

3. The imprint method according to claim 1, wherein the application condition includes at least one of an application amount of the drop, an arrival position of the drop, or a volatilizing amount of the drop after application.

4. The imprint method according to claim 3, wherein a volume of the drop is obtained based on the acquired information and the application condition is determined based on the volume.

5. An imprint apparatus for forming a pattern of an imprint material on a substrate, the imprint apparatus comprising:
a substrate holder that holds the substrate;
a dispenser that applies a drop of the imprint material to the substrate held by the substrate holder;
an observing unit that observes a Newton's ring or a diameter of the drop applied to the substrate; and
a control unit configured to determine an application condition of the dispenser in forming the pattern based on the Newton's ring or the diameter of the drop observed by the observing unit.

6. A method for manufacturing an article, the method comprising:
forming a pattern of an imprint material on a substrate using an imprint method; and
processing the substrate on which the pattern has been formed in the forming,
wherein the imprint method includes:
applying a drop of the imprint material to the substrate;
observing the applied drop;
acquiring information concerning a Newton's ring and a diameter based on the observation result; and
determining an application condition of the imprint material in forming the pattern from the acquired information.
